(19) United States
(12) Patent Application Publication
(10) Pub. No.: US 2008/0249852 A1
(43) Pub. Date: Oct. 9, 2008

(54) SYSTEMS AND METHODS FOR CREATING ADVERTISEMENTS

(75) Inventors: CHYR-CHONG JOSEPH TING, SAN JOSE, CA (US); ADAM HYDER, LOS ALTOS, CA (US)

Correspondence Address: YAHOO! INC. C/O GREENBERG TRAURIG, LLP, MET LIFE BUILDING, 200 PARK AVENUE, NEW YORK, NY, 10166, US

(73) Assignee: YAHOO! INC., SUNNYVALE, CA (US)

(21) Appl. No.: 11/696,152

(22) Filed: Apr. 3, 2007

(51) Int. Cl. G06Q 30/00

(52) U.S. Cl. 705/14

(57) ABSTRACT

Methods and systems of creating online advertisements are disclosed herein. An advertisement creation request can be received from an advertiser. The advertisement creation request can be submitted by the advertiser to create an online advertisement associated with an advertisement campaign. Advertisement rules can be received from the advertiser. The advertisement rules can define how the online advertisement is to be created. A job listing can be posted on an online market. The job listing can be associated with an advertising job that entails the creation of the online advertisement according to advertisement rules. A proposal from an advertisement creator for performing the advertising job associated with the job listing can be received. The received proposal can be communicated to the advertiser.

### BACKGROUND

1. Field

The present disclosure relates to online advertisement. In particular, it relates to systems and methods of creating online advertisements and listing job listings.

2. General Background

Internet advertising has become a prime direct marketing channel for companies selling goods and services. Internet companies rely on advertisement creators such as freelancers and advertisement firms to create advertisements. As part of implementing and creating advertisement campaigns, Internet companies must provide ready-for-publication advertisements to advertisement service providers such as Yahoo!. In general, small Internet companies have a limited budget to implement advertisement campaigns. In addition, freelancers and other small advertisement creators have limited exposure to advertisement creation jobs.

### SUMMARY

Methods and systems of creating online advertisements are disclosed herein. An advertisement creation request can be received from an advertiser. The advertisement creation request can be submitted by the advertiser to create an online advertisement associated with an advertisement campaign. Advertisement rules can be received from the advertiser. The advertisement rules can define how the online advertisement is to be created. A job listing can be posted on an online market. The job listing can be associated with an advertising job that entails the creation of the online advertisement according the advertisement rules. A proposal from an advertisement creator for performing the advertising job associated with the job listing can be received. The received proposal can be communicated to the advertiser.

In another aspect, the advertisement rules can include color, size, required language, required logos, a price range, and the like.

In a further aspect, the proposal includes a draft of the online advertisement, a sample of previous online advertisements created by the advertisement creator, demographic information about the advertisement creator, or any other data that can convey a proposal.

In a further aspect, the search request by the advertisement creator to search for job listings in which the advertisement creator is interested can be received.

In a further aspect the method, job listings that match profile data of the advertisement creator are automatically generated. In another aspect of the method, the advertisement created by the creator on a website can be posted.

In one aspect, there is a system to provide advertisements, comprising a campaign manager, an advertisement database, and a proposal submission module. The campaign manager receives an advertisement creation request from an advertiser. The advertisement creation request can be submitted by the advertiser to create an online advertisement associated with an advertisement campaign. The campaign manager is further configured to receive advertisement rules from the advertiser. The advertisement rules can define how the online advertisement is to be created. The advertisement database can be configured to store a job listing. The job listing can be associated with an advertising job that entails the creation of the online advertisement according the advertisement rules. A proposal submission module receives a proposal from an advertisement creator for performing the advertising job associated with the job listing. The proposal submission module can be further configured to communicate the received proposal to the advertiser.

### DRAWINGS

The features and objects of alternate embodiments of the present disclosure will become more apparent with reference to the following description taken in conjunction with the accompanying drawings of various examples wherein like reference numerals denote like elements and in which:

FIG. 1 depicts a component diagram of a system for providing advertisements according to one embodiment.

FIG. 2 depicts a component diagram of an exemplary campaign manager according to one embodiment.

FIG. 3 depicts a component diagram of a computing device according to one embodiment.

FIG. 4 depicts a flow diagram of a process for creating online advertisements according to one embodiment.

FIG. 5 depicts an exemplary user interface for posting a job listing according to one embodiment.

FIG. 6 depicts an exemplary user interface for permitting an advertisement creator to perform a search according to one embodiment.

FIG. 7 depicts an exemplary user interface for providing advertising job search results to an advertisement creator according to one embodiment.

### DETAILED DESCRIPTION

Various methods and systems for advertisement creation are disclosed. An advertisement market wherein Internet advertisers can submit advertising jobs and advertisement creators can apply or propose an advertisement that satisfies the advertisers' needs is disclosed. As disclosed herein, advertisers generally include Internet companies that desire to market a product or service on the Internet. Advertisers can submit, via the Internet or other computer network, a request for advertisement creation request. An advertisement creation request can be an initial submittal by an advertiser that includes parameters for generating a job listing. As used herein, a job listing is a job listing posted on a website or online resource that indicates a one-time or ongoing project for creating an online advertisement or an advertisement campaign. Likewise, as utilized herein, an advertising job is the corresponding work that needs to be performed in association with a job listing.

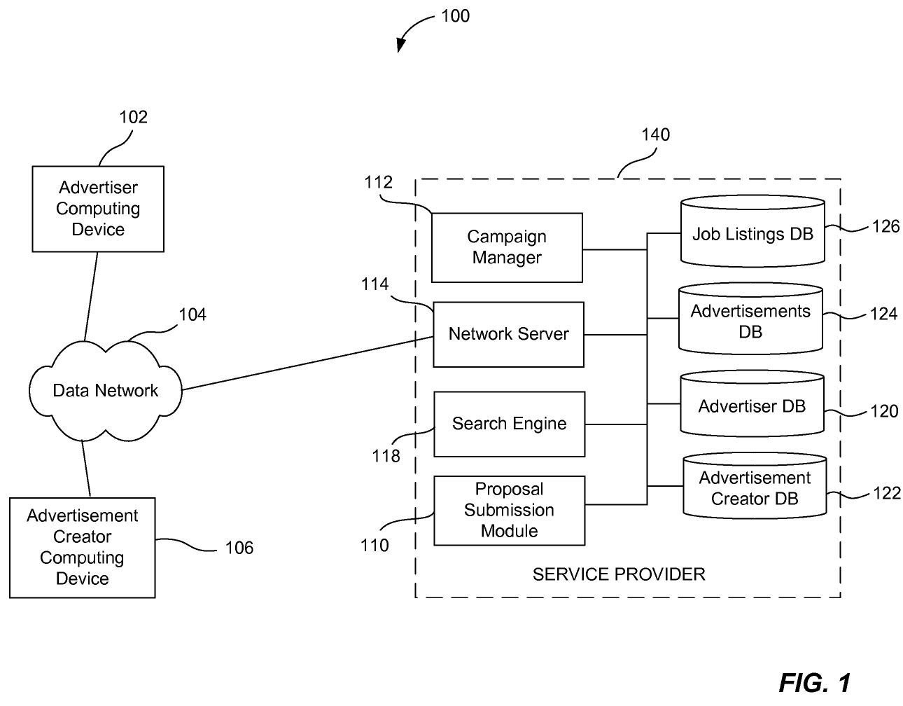

FIG. 1 depicts a component diagram of a system for providing advertisements according to one embodiment. In one embodiment, the service provider 140 can host one or more online services. As such the service provider 140 can be a business entity that owns and operates a computer infrastructure connected to a data network 104 in order to provide a plurality of advertisement services that can be accessed by advertisers. Advertisers can access the verticals provided by the service provider 140 via a data network 104. In one embodiment, the data network 104 is the Internet. In another embodiment, the data network 104 is an intranet. An advertiser can utilize an advertiser computing device 102 to communicate via the data network 104 with one or more computing modules and or services that are part of the computer infrastructure managed by the service provider 140.

In one embodiment, the advertiser computing device 102 can be configured with a web browser that allows the advertiser computing device 102 to send data to and receive data from a network server 114. The advertiser computing device 102 communicates with the network server 114 to render web pages received from the network server 114, as well as transmit advertiser input to the network server 114. In another embodiment, the advertiser computing device 102 can communicate through the data network 104 via any client-side application configured to communicate in a predetermined protocol with the network server 114.

In addition, the service provider 140 can be accessed by advertisement creators via an advertisement creator computing device 106. In one embodiment, the advertisement creator computing device 106 can be configured with a web browser that allows the advertisement creator computing device 106 to send data to and receive data from a network server 114.

In one embodiment, the network server 114 is configured as a portal to multiple verticals provided by the service provider 140. As such, the network server can provide multi-vertical access to an advertiser, or to an advertisement creator. For example, the advertiser may access an advertisement vertical, create advertisement campaigns, set parameters of advertisements, upload online advertisements, submit requests for the creation of advertisements, etc. In this example, the network server 114 can communicate with processes, modules, and any other computer infrastructure that can allow the advertiser to interact and manage its advertisements. In another example, the advertiser can provide information of job listing services, etc. through the network server 114. As one skilled in the art will understand, the network server can be a plurality of servers, each of which can be a server that is dedicated for a specific vertical.

In one embodiment, the server provider 140 can further include a campaign manager 112. The campaign manager 112 allows the advertiser to administrate the advertiser's account, create new campaigns, upload advertisements, view bids on advertisement real estate, view click-through rates, view payment information, etc. The advertiser can interact through the advertiser computing device 102 over the data network 104 with the campaign manager 112. As such, the campaign manager 112 can be configured with logic and/or software to permit the advertiser to create a new campaign to configure details, rules, objectives and/or requirements of an advertisement campaign. In one embodiment, an advertiser database 120 that stores profiles of advertisers can be part of the computer infrastructure of the service provider 140. The profiles can store preferences of advertisement campaigns and other information related to the advertiser. In addition, advertisements uploaded by an advertiser can be stored in an advertisements database 124.

In another embodiment, the campaign manager 112 can be configured to receive an advertisement creation request from the advertiser. The advertisement creation request can be submitted by the advertiser in order to request that an advertisement be created. The advertiser can further provide to the campaign manager 112 associated advertisement rules in order to define how the advertisement is to be created. For example, if the advertiser is a merchant that provides telecommunication services, the advertiser can require that the language “best telecommunications” be included in the online advertisement. As explained below, the advertiser can detail one or more rules for the creation of the online advertisement. The campaign manager 112 can post the advertisement creation request submitted by the advertiser.

In one embodiment, the advertisement creation requests can be posted as job listings that are displayed on a website where one or more advertisement creators can access job listings that are posted or submitted by an advertiser. The job listings can be stored at a job listings database 126. In one example, the campaign manager 112 can access the job listings database 126 in order to retrieve the available job listings and display such job listings on a website. In another embodiment, a search engine 118 can access the job listings database 126 in order to search, based upon criteria submitted by the advertisement creator, for job listings in the job listings database 126. The search criteria submitted by the advertisement creator can be provided to the search engine 118 in order to render search results that are relevant to the interest of the advertisement creator. For example, an advertisement creator may be interested or have expertise in working with advertisements created for the computer industry. The advertisement creator can submit a search for job listings related to the computer industry. The search engine 118 can then perform the search according to the interests or expertise of the advertisement creator.

In another embodiment, the search engine 118 can be configured to automatically search for job listings in the job listings database 126 that best match the qualification preferences or interests of an advertisement creator. The search engine 118 can search in the advertisement creator database 122 in order to determine, by searching profiles of advertisement creators, the preferences, address and qualifications or expertise of different advertisement creators' profiles. Upon determining matching job listings the search engine 118 can provide a list of job listings to the advertisement creator automatically. For example, the search engine 118 can submit an electronic mail or an SMS message or any other form of electronic communication that alerts the advertisement creator of new job listings submitted by advertiser. In another embodiment, the search engine 118 can be configured to submit alerts to advertisers that an advertisement creator has been submitted, subscribed or registered with the service provider 140 and that would be a good match for creating advertisements for the advertiser. Again, the search engine 118 can provide this match by searching the advertisement creator database 122 and comparing the profile qualifications with the requirements of the job listings stored in the job listings database 126.

In another embodiment, an advertisement creator can submit a proposal based on job listings search, received or otherwise learned by the advertisement creator. As such, once the advertisement creator becomes aware of a job listing that is available, the advertisement creator can select to submit a proposal for working on the advertising job associated with the job listing. In one embodiment, the advertisement creator can utilize the advertisement creator computing device 106 in order to submit the proposal. In one example, the proposal can be transmitted to data network 104, and then to the service provider 140. The proposal can be received at a network server 114 that communicates with the software and/or logic associated with the proposal submission module 110. Through one or more user interfaces, the advertisement creator can provide an indication that the advertisement creator is interested in creating the advertisement corresponding to the job listing. For example, the advertisement creator can submit previous work performed or created by the advertisement creator such as previous online advertisements created by the advertisement creator. In another embodiment, the proposal can include a draft or a prototype submitted by the advertisement creator and that is relevant or related to the job listing.

Once the proposal is received at the proposal submission module 110, the proposal submission module 110 can submit a message or send the received proposal to the campaign manager 112. The campaign manager 112 can then list the proposal of the advertisement creator and the proposals of other advertisement creators in connection with the same job listing.

In a further embodiment, the campaign manager 112 can then present the multiple proposals by advertisement creators to the advertiser. For example, the campaign manager 112 can alert the advertiser, via any electronic messaging system such as email or SMS message to a portable device.

The advertiser can then access the infrastructure of the service provider 140 and view through the campaign manager 112 one or more proposals submitted by various advertisement creators. In one embodiment, the proposals are stored with each corresponding job listings at the job listings database 126. The advertiser can then select the best proposal for performing the job associated with the job listing. One skilled in the art will understand that an job listing stored at the job listings database 126 can be related to creating one or multiple online advertisements.

As such, the proposal submission module 110 receives one or more proposals from advertisement creators interested in performing the advertising job associated with the job listing. The proposal submission module 110 can also be configured to communicate the proposal to the advertiser.

While various databases have described herein, one skilled in the art will recognize that each of the aforementioned databases can be combined into one or more data repositories, and be located either locally or remotely. In addition, each of the aforementioned databases can be any type of data repository configured to store data and can be implemented using any methods of storage now known or to become known. Likewise, while various modules have described herein, one skilled in the art will recognize that each of the aforementioned modules can be combined into one or more modules, and be located either locally or remotely. Each of these modules can exist as a component of a computer program or process, or be standalone computer programs or processes recorded in a data repository.

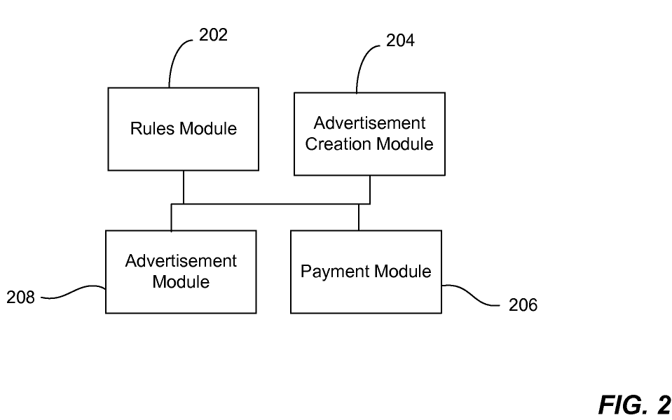

FIG. 2 depicts a component diagram of an exemplary network server according to one embodiment. In one embodiment, the campaign manager 112 can include a rules module 202. The rules module 202 can be configured with logic to prompt advertisers for rules relating to the creation of online advertisements. As such, the rules module 202 can be configured to prompt the advertiser for rules that define objectives and other parameters as related to online advertisements required or requested by the advertiser. The rules module 202 can further be configured with logic to store the rules received from the advertiser in connection with a particular job listing and store such rules in the job listings database 126. Rules associated with a job listings can include payment information, deadlines or completion date, requirements of submitting drafts and any other requirements that an advertiser can associate to a job listing.

The campaign manager 112 can further include an advertisement creation module 204. The advertisement creation module 204 can be configured to upload advertisements created by the advertiser and store such advertisements in the advertisements database 204. In another embodiment, the advertisement creation module 204 can also be configured to receive advertisement creation requests and process such requests so as to post job listings and/or store such job listings for searching by advertisement creators.

The campaign manager 112 can also include an advertisement module 208. The advertisement module 208 can be configured with logic to retrieve advertisements from the advertisements database 124 and display such advertisements according to advertisement campaigns established by the advertiser. As such, the advertisement module 208 can be configured to store at the advertiser database 120 multiple parameters and preferences regarding configurations of advertisement campaigns of the advertiser, frequency of display of the advertisements, etc.

In a further embodiment, the campaign manager 112 can also include a payment module 206. The payment module 206 can permit an advertiser to manage payment or payments to advertisement creators that have been contracted or employed by the advertiser. For example, if the advertisement creator creates an online advertisement in response to a job listing, the advertiser can pay the advertisement creator through the payment module 206. As such, the payment module 206 can be configured to interact with the advertisement creator database 122 and the advertiser database 120 in order to process payment to advertisement creators stored at the advertisement creator database 122. In addition, the payment module 206 can also be configured with logic to aid the advertiser to make payments to the service provider 140 based on advertisements displayed by the service provider 140.

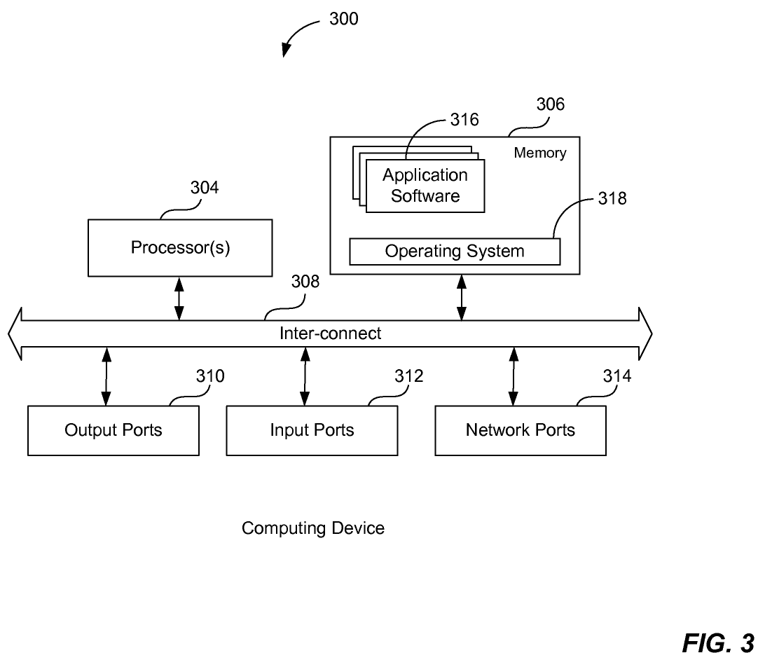

FIG. 3 depicts a component diagram of a computing device according to one embodiment. The computing device 300 can be utilized to implement one or more computing devices, computer processes, or software modules described herein. In one example, the computing device 300 can be utilized to process calculations, execute instructions, receive and transmit digital signals, as required by the advertiser computing device 102 or the advertisement creator computing device 106. The computing device 300 can be utilized to process calculations, execute instructions, receive and transmit digital signals and/or data as required by the campaign manager 112, the network server 114, the search engine 118, the proposal submission module 110, and rules module 202, the advertisement creation module 204, the advertisement module 208, and the payment module 206.

The computing device 300 can be any general or special purpose computer now known or to become known capable of performing the steps and/or performing the functions described herein, either in software, hardware, firmware, or a combination thereof.

The computing device 300 includes an inter-connect 308 (e.g., bus and system core logic), which interconnects a microprocessor(s) 304 and memory 306. The inter-connect 308 interconnects the microprocessor(s) 304 and the memory 306 together. Furthermore, the interconnect 308 interconnects the microprocessor 304 and the memory 306 to peripheral devices such input ports 312 and output ports 310. Input ports 312 and output ports 310 can communicate with I/O devices such as mice, keyboards, modems, network interfaces, printers, scanners, video cameras and other devices. In addition, the output port 310 can further communicate with the display 104.

Furthermore, the interconnect 308 may include one or more buses connected to one another through various bridges, controllers and/or adapters. In one embodiment, input ports 312 and output ports 310 can include a USB (Universal Serial Bus) adapter for controlling USB peripherals, and/or an IEEE-1394 bus adapter for controlling IEEE-1394 peripherals. The inter-connect 308 can also include a network connection 314.

The memory 306 may include ROM (Read Only Memory), and volatile RAM (Random Access Memory) and non-volatile memory, such as hard drive, flash memory, etc. Volatile RAM is typically implemented as dynamic RAM (DRAM), which requires power continually in order to refresh or maintain the data in the memory. Non-volatile memory is typically a magnetic hard drive, flash memory, a magnetic optical drive, or an optical drive (e.g., a DVD RAM), or other type of memory system which maintains data even after power is removed from the system. The non-volatile memory may also be a random access memory.

The memory 306 can be a local device coupled directly to the rest of the components in the data processing system. A non-volatile memory that is remote from the system, such as a network storage device coupled to the data processing system through a network interface such as a modem or Ethernet interface, can also be used. The instructions to control the arrangement of a file structure may be stored in memory 306 or obtained through input ports 312 and output ports 310.

In general, routines executed to implement one or more embodiments may be implemented as part of an operating system 318 or a specific application, component, program, object, module or sequence of instructions referred to as application software 316. The application software 316 typically can comprises one or more instruction sets that can be executed by the microprocessor 304 to perform operations necessary to execute elements involving the various aspects of the methods and systems as described herein. For example, the application software 316 can include video decoding, rendering and manipulation logic.

Examples of computer-readable media include but are not limited to recordable and non-recordable type media such as volatile and non-volatile memory devices, read only memory (ROM), random access memory (RAM), flash memory devices, floppy and other removable disks, magnetic disk storage media, optical storage media (e.g., Compact Disk Read-Only Memory (CD ROMS), Digital Versatile Disks, (DVDs), etc.), among others. The instructions may be embodied in digital and analog communication links for electrical, optical, acoustical or other forms of propagated signals, such as carrier waves, infrared signals, digital signals, etc.

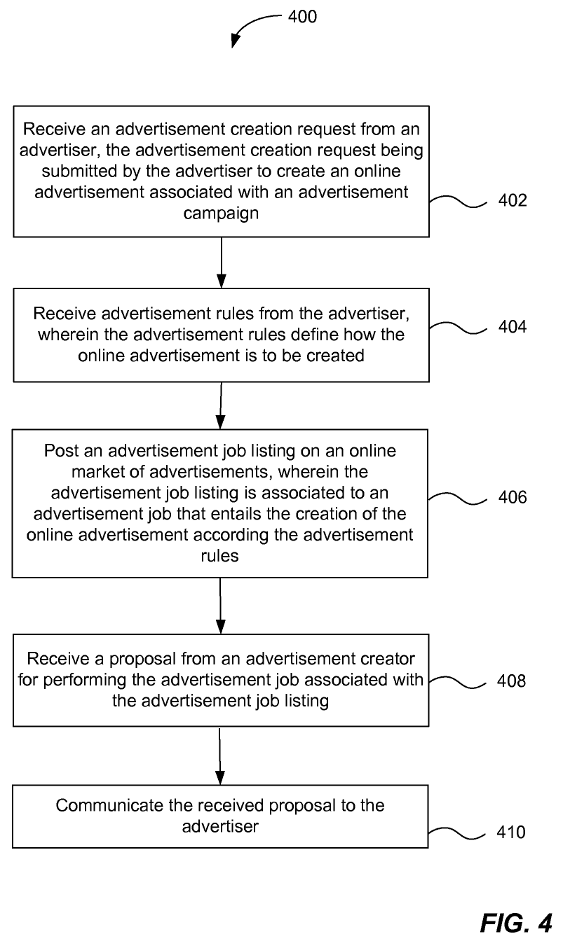

FIG. 4 depicts a flow diagram of a process for creating online advertisements according to one embodiment. At process block 402, an advertisement creation request is received from an advertiser. The advertisement creation request can be submitted by the advertiser in order to request the creation of an online advertisement. The online advertisement can be for example associated with an advertisement campaign that the advertiser has implemented. Process 400 continues at process block 404.

At process block 404, advertisement rules are received from the advertiser. As previously mentioned, advertisement rules can include rules that define how the online advertisement is to be created. For example, the rules provided by the advertiser may include rules indicating the color, shape, font utilized, images, required language, prohibited language, specific message conveyed, logos or any other pre-specified content that the advertiser wants to include in an advertisement. In another example, the advertisement rules can include size of the advertisement, resolution, format of the image or content, etc. In yet another example, the advertisement rules may include time for completion, payment information, required quality, etc. Process block 400 continues at process block 406.

At process block 406, a job listing is posted on an online market of advertisements. The online market of advertisements can for example be a website that lists recently posted job listings. In another example, the online market of advertisements database that an advertisement creator can access and search. The job listing can be associated with an advertising job. In one example, the advertising job entails the creation of the online advertisement according to the advertisement rules established by the advertiser. Process 400 continues at process block 408.

At process block 408, the proposal from an advertisement creator is received. The proposal received from the advertisement creator can be indicative of the advertisement creator's wish to perform the advertising job associated with the job listing. In one example, the advertisement creator is a freelancer that works as a contractor independently and works on a project-to-project basis. In another embodiment, the advertisement creator can be a third party consulting firm that creates advertisements for merchants.

In one embodiment, the advertisement creator can submit a proposal to create the advertisement by submitting a cover letter, company profile or a resume of sample work, proposed work, etc. Process 400 continues at process block 410.

At process block 410, the received proposal is communicated to the advertiser. In one embodiment, the proposal can be communicated to the advertiser by submitting an email message to the advertiser or any other electronic alert that permits an advertiser to become aware that one or more advertisement creators have submitted a proposal in relation to the advertiser creation request originally submitted by the advertiser. Once the proposal is received by the advertiser, the advertiser can then choose to accept or decline the proposal by the advertisement creator. In addition, the advertiser can visit one or more websites provided by the service provider 140 and further search through the search engine 118 for advertisement creators according to profiles of the advertisement creators.

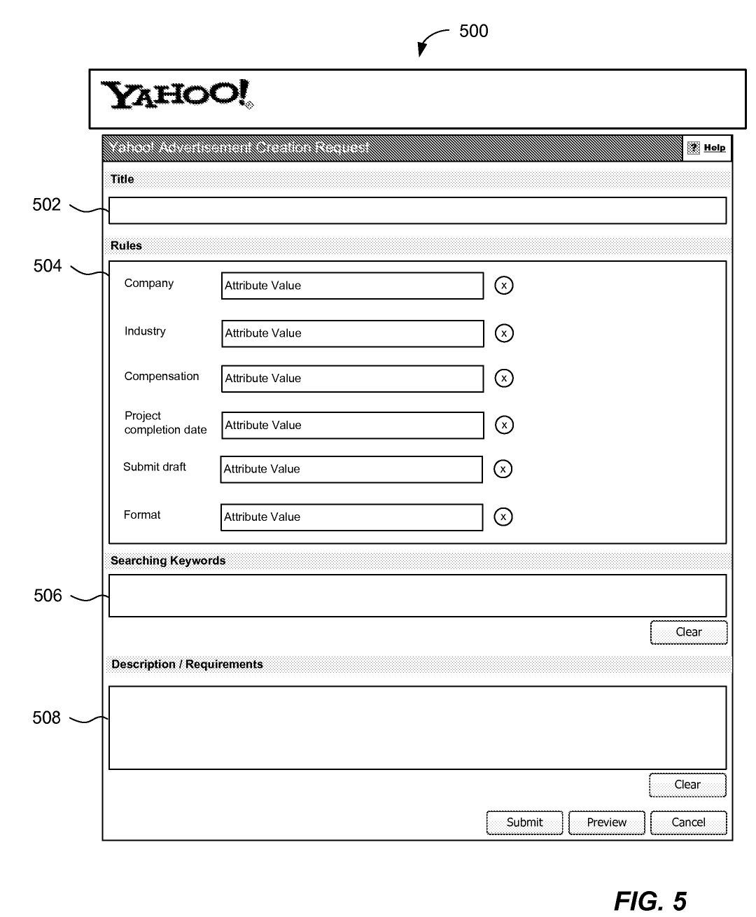

FIG. 5 depicts an exemplary user interface for posting a job listing according to one embodiment. The user interface 400 can include multiple fields to permit an advertiser to enter an advertisement creation request. A field 502 can be provided for the advertiser to enter the title of the project or advertisement creation request. In addition, fields 504 can be provided as part of the user interface 400 so that the advertiser can enter one or more rules associated with the advertisement creation request. As previously mentioned, the rules can include the company name of the advertiser, the industry associated with the advertisement requested, the compensation for creating the advertisement, the project completion date by when the advertisement needs to be created and submitted, a submit draft requirement, a format requirement for the advertisement, etc. In addition, the user interface 400 can also provide a field 506 for the advertiser to enter keywords associated with the advertisement creation request. The keywords can be entered such that advertisement creators can search for advertisement creation requests, and find those advertisement creation requests having associated job listings in which the advertisement creator is interested. Furthermore, the user interface 400 can also include a field 508 that permits an advertiser to enter further description of requirements associated with the advertisement creation request. For example, the maximum budget of the project, the size or number of online advertisement required by the advertisement creation request, or any other specific custom requirements or preferences can be included as part of the description requirements in the field 508. Once the advertisement creation request is received by the service provider 140, the campaign manager 112 can generate a job listing associated with the advertisement creation request that is stored at the job listing database 126 and searchable by the search engine 118.

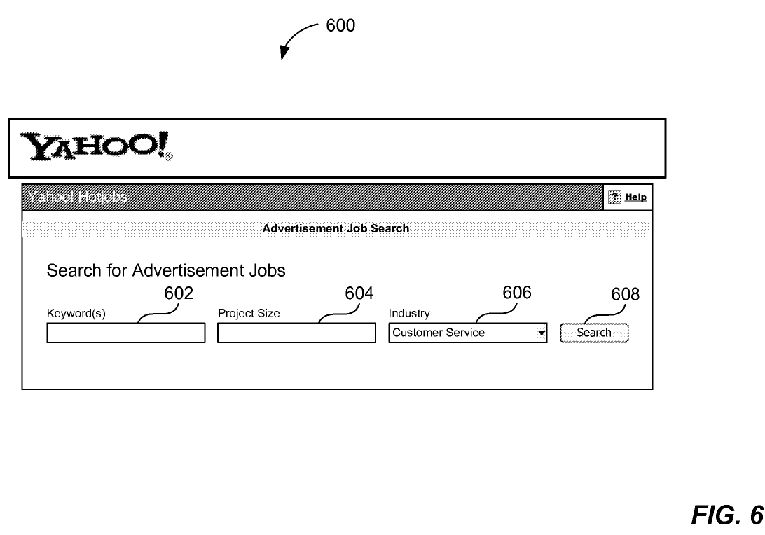

FIG. 6 depicts an exemplary user interface for permitting an advertisement creator to perform a search according to one embodiment. User interface 500 permits an advertisement creator to look for advertising jobs that have been listed as job listings associated with advertisement creation requests. As previously mentioned, once an advertisement creation request is submitted by an advertiser, the campaign manager 112 can generate a related job listing that is listed for viewing by advertisement creators. The job listing can include some information submitted by the advertiser when submitting the advertisement creation request. One or more fields can be provided to the advertisement creator in order to search for job listings. In one embodiment, a field 602 permits an advertisement creator to enter keywords associated with a job listing. A field 604 permits an advertisement creator to search for job listings based on the project size. A field 606 permits an advertisement creator to search for job listings according to the industry to which the advertisement pertains. In addition, a search button 608 can be provided as part of the user interface 600 such that the advertisement creator can search in a customized fashion for job listings.

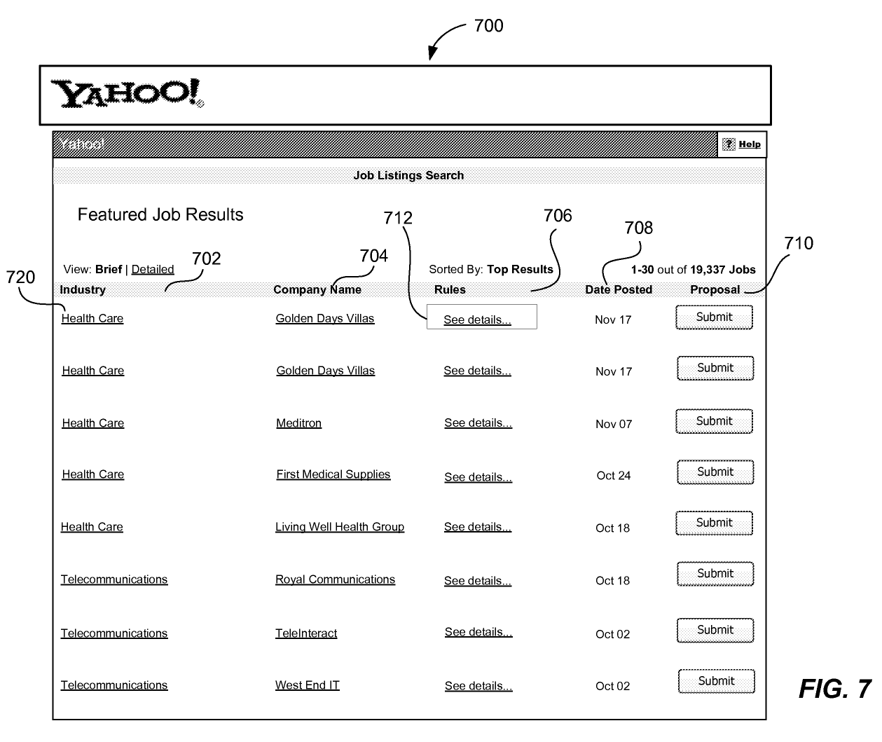

FIG. 7 depicts an exemplary user interface for providing advertisement and job search results to an advertisement creator according to one embodiment. User interface 700 can include a list of job listings resulting from a search submitted by an advertisement creator. In one example, the user interface includes a column 702 for indicating the industry to which the job listing pertains. Likewise, a column 704 can be included to indicate the company to which the job listing would be created for. For example, the company name would be the advertiser's name. Furthermore, a column 706 can be provided with a link such that an advertisement creator can select to view further details and rules associated with the job listing. Furthermore, a column 708 can be provided for indicating the date when the job listing was generated and posted. Additionally, a column 710 can be provided with a button corresponding to each of the job listings so that the advertisement creator can select the submit proposal button in order to submit proposals for the selected job listing.

Other user interfaces and features may be also incorporated. In one example, a user interface can be provided to allow the advertiser to rate or provide feedback of the work performed by the advertisement creator. Thus, the advertisement may be provided with a form or other user interface to enter text and provide feedback. In another aspect, the advertiser may be able to provide a degree or number or other indicator.

Those skilled in the art will recognize that the methods and systems of the present disclosure may be implemented in many manners and as such are not to be limited by the foregoing exemplary embodiments and examples. In other words, functional elements being performed by a single or multiple components, in various combinations of hardware and software or firmware, and individual functions can be distributed among software applications at either the client or server level or both. In this regard, any number of the features of the different embodiments described herein may be combined into single or multiple embodiments, and alternate embodiments having fewer than or more than all of the features herein described are possible.

Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, and those variations and modifications that may be made to the hardware or software or firmware components described herein as would be understood by those skilled in the art now and hereafter.

1. A method of creating online advertisements, comprising:
receiving an advertisement creation request from an advertiser, the advertisement creation request being submitted by the advertiser to create an online advertisement associated with an advertisement campaign;
receiving advertisement rules from the advertiser, wherein the advertisement rules define how the online advertisement is to be created;
posting a job listing on an online market, wherein the job listing is associated with an advertising job that entails the creation of the online advertisement according the advertisement rules;
receiving a proposal from an advertisement creator for performing the advertising job associated with the job listing; and
communicating the received proposal to the advertiser.

2. The method of claim 1, wherein the advertisement rules include color, size, required language, required logos.

3. The method of claim 1, wherein the advertisement rules include a price range.

4. The method of claim 1, wherein the proposal includes a draft of the online advertisement.

5. The method of claim 1, wherein the proposal includes a sample of previous online advertisements created by the advertisement creator.

6. The method of claim 1, wherein the proposal includes demographic information about the advertisement creator.

7. The method of claim 1, further comprising receiving a search request by the advertisement creator to search for job listings in which the advertisement creator is interested.

8. The method of claim 1, further comprising automatically generating job listings that match profile data of the advertisement creator.

9. The method of claim 1, further comprising posting the advertisement created by the creator on a website.

10. A system to provide advertisements, comprising:
a campaign manager that receives an advertisement creation request from an advertiser, the advertisement creation request being submitted by the advertiser to create an online advertisement associated with an advertisement campaign, wherein the campaign manager is further configured to receive advertisement rules from the advertiser, the advertisement rules defining how the online advertisement is to be created;
an advertisement database configured to store a job listing, wherein the job listing is associated with an advertising job that entails the creation of the online advertisement according the advertisement rules; and
a proposal submission module that receives a proposal from an advertisement creator for performing the advertising job associated with the job listing, wherein the proposal submission module is further configured to communicate the received proposal to the advertiser.

11. The system of claim 10, wherein the advertisement rules include color, size, required language, required logos.

12. The system of claim 10, wherein the advertisement rules include a price range.

13. The system of claim 10, wherein the proposal includes a draft of the online advertisement.

14. The system of claim 10, wherein the proposal includes a sample of previous online advertisements created by the advertisement creator.

15. The system of claim 10, wherein the proposal includes demographic information about the advertisement creator.

16. The system of claim 10, further comprising a search engine that receives a search request by the advertisement creator to search for job listings in which the advertisement creator is interested.

17. The system of claim 10, further comprising a search engine that is configured to automatically generate job listings that match profile data of the advertisement creator.

18. The system of claim 10, wherein the campaign manager is further configured to post the advertisement created by the advertisement creator on a website.
